(19) United States
(12) Patent Application Publication
(10) Pub. No.: US 2026/0269550 A1
(43) Pub. Date: Sep. 10, 2026

(54) METHOD OF ATTACHING ELECTRICAL CONNECTIONS TO PRINTED CIRCUIT BOARDS

(71) Applicant: Sikai Chen, Delran, NJ (US)

(72) Inventor: Sikai Chen, Delran, NJ (US)

(21) Appl. No.: 19/071,984

(22) Filed: Mar. 6, 2025

(51) Int. Cl. H01R 43/02; F21S 4/24; F21V 23/00; F21Y 103/10; F21Y 115/10; H01R 4/02

(52) U.S. Cl. CPC H01R 43/0256; F21S 4/24; F21V 23/001; H01R 4/024; H01R 43/0228; F21Y 2103/10; F21Y 2115/10

(57) ABSTRACT

A method for soldering electrical connections to printed circuit boards (PCB) having a plurality of LED lights and adjacent PCB pads provides for the application and placement of solder directly onto the PCB pads, attaching electrically conductive metal pieces to the terminus of positive and negative electrode wires, placing the metal pieces which are on the wires onto the solder of the PCB pads, and heating the conductive wire pieces to ultimately create a fixed soldered connection between the metal pieces and the printed PCB pads and hence the PCB itself.

### FIELD OF THE INVENTION

The present invention generally relates to the manner of applying soldering connections for affixing electrode wiring to printed circuit boards (PCB).

### BACKGROUND OF THE INVENTION

Traditional methods for soldering PCB connections are complex, time consuming and dependent on skilled labor. Such methods usually require multiple steps; that is melting solder wire material, applying the solder to the electrode wire, attaching the electrode wire to the PCB, and finally applying solder paste to complete the joint. This manual soldering is slow and wastes considerable time, thus reducing overall productivity. In addition, traditional soldering equipment is bulky and complex, making it difficult to use in outdoor or field work environments. Importantly, the quality of the solder joint can vary significantly between novice and skilled technicians, leading to potential defects due to inconsistent solder application and heating times.

### SUMMARY OF THE INVENTION

It is thus the object of the present invention to overcome the disadvantages and limitations of existing PCB electrical soldering connection methods by providing a significantly improved method for soldering electrical connections to PCBs.

It is an object of the present invention to provide an improved method for soldering electrical connections to PCBs by using a metal piece attached to the electrode wire to directly heat and melt solder previously applied to a PCB pad on the PCB, thereby dramatically reducing the process time.

It is another object at the present invention to provide an improved method for soldering electrical connections to PCBs which can readily be performed by nonprofessional personnel, thereby reducing the need for highly skilled technicians.

It is a further object of the present invention to provide an approved method for soldering electrical connections to PCBs which is effective, efficient, and simple, making it ideal for use in outdoor environments and fieldwork with easily portable equipment.

These and other objects are accomplished by the present invention, a method for soldering electrical connections to PCBs having a plurality of LED lights and adjacent PCB pads. The method provides for the application and placement of solder directly onto the PCB pads, attaching electrically conductive metal pieces to the terminus of positive and negative electrode wires, placing the metal pieces which are on the wires onto the solder of the PCB pads, and heating the conductive wire pieces to ultimately create a fixed soldered connection between the metal pieces and the printed PCB pads and hence the PCB itself.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a view of components of the method of the present invention.

FIG. 2 is an elevation view of the components shown FIG. 1.

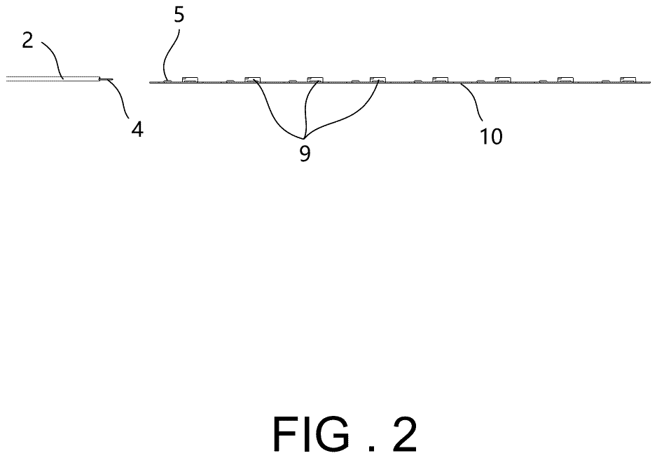

FIG. 3 illustrates a step of the method of the present invention.

FIG. 4 shows the printed circuit board, fixedly attached to positive and negative electrode wires upon completion of the method of the present invention.

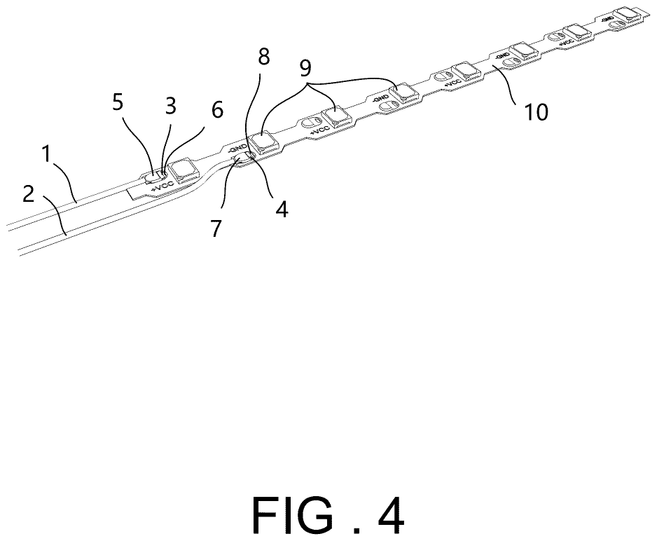

FIG. 5 is an elevation view of the printed circuit board shown in FIG. 4.

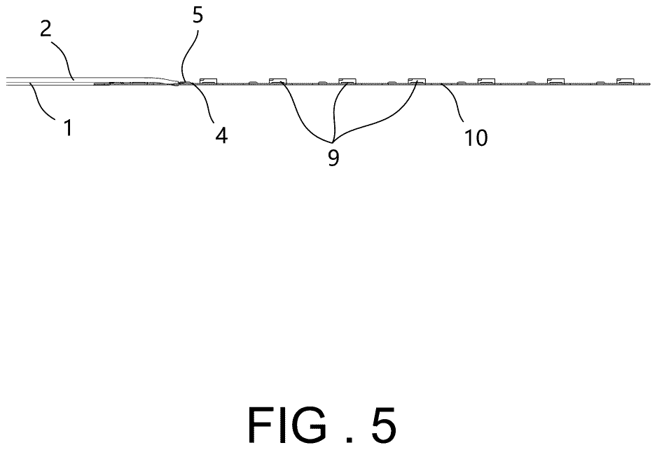

### DETAILED DESCRIPTION OF THE INVENTION

The method of the present invention provides for a simple and effective means of soldering electrical connections to a printed circuit board (PCB) as follows.

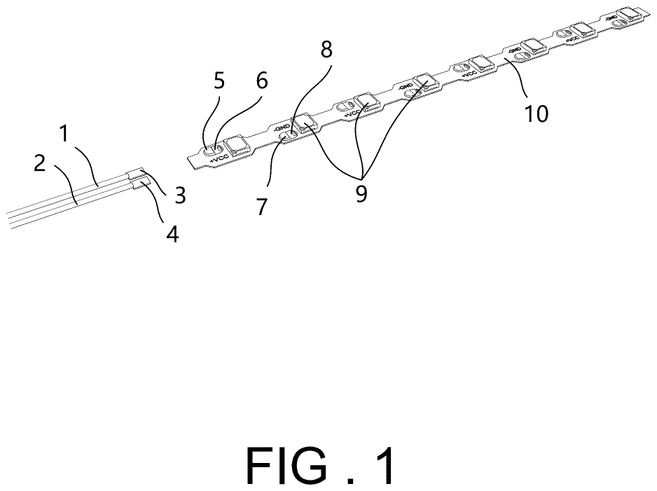

PCB 10 comprises a plurality of LED lights 9. PCB pads, e.g. pads 6 and 8 made of copper or like electrically conductive material, are located in the vicinity of each LED light 9. A small patch of solder is placed and applied directly on each PCB pad, e.g. solder 5 and 7. See FIG. 1.

Electrically conductive metal pieces 3 and 4 are attached to the terminus of positive electrode wire 1 and negative electrode wire 2 respectively. Attachment can be by means of electrical wiring connection, crimping, or similar known means. See FIG. 1.

To form the electrical connection, conductive metal piece 3 is placed on solder 5 of PCB pad 6. Welding gun 11 is then used to heat conductive metal piece 3 on positive electrode wire 1. Solder 5 is then allowed to cool, which results in the fusing of metal piece 3 of positive electrode wire 1 to PCB pad 6, thus forming a soldered, fixed connection between the metal piece and the PCP pad and hence PCB 10.

Next, conductive metal piece 4 is placed on solder 7 of PCB pad 8. Welding gun 11 is used to heat conductive metal piece 4 on negative electrode wire 2. Solder 7 is allowed to cool, which results in the fusing of metal piece 4 on negative electrode wire 2 to PCB pad 8, thus forming a soldered, fixed connection between the metal piece and the PCB pad, and hence PCB 10.

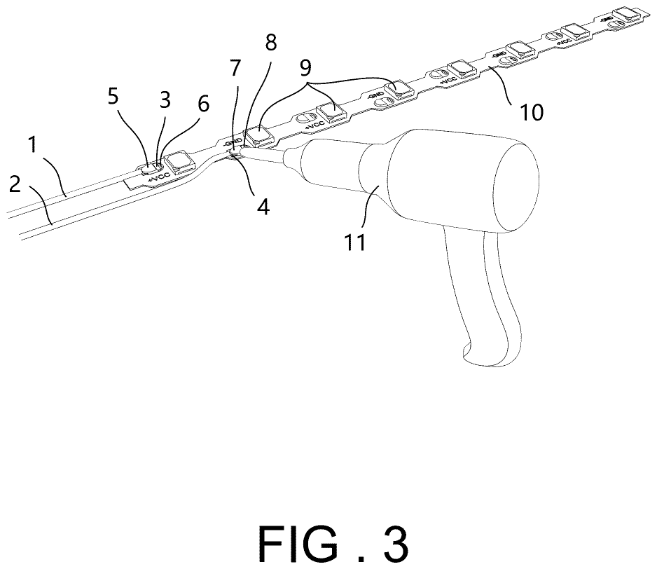

FIG. 3 illustrates the final result of the attachment of electrode wire 1 to PCB 10 by means of the soldered connection of metal piece 3 to PCB pad 6, affixed by solder 5. Also illustrated in FIG. 3 is the process of attachment of electrode wire to 2 to PCB 10, showing welding gun 11 being used to heat metal piece 4 to attach the electrode wire to PCB 10 by the fusion of the metal piece to PCB pad 8.

During the heating of metal pieces 3 and 4, care must be taken to provide the heat from welding gun 11 at temperatures and for durations of time which prevent overheating, which could damage the metal pieces or PCB 10.

As a result of the soldered connection of metal pieces 3 and 4 to PCB 10, electrical power from positive electrode wire 1 and negative electrode wire 2 can be transmitted to PCB 10 to illuminate LED lights 9.

It is contemplated and should be understood that electrode wires 1 and 2 can be affixed to any two of the PCB pads on the PCB in order to provide the required electrical power to PCB 10.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A method for soldering electrical connections to printed circuit boards, said steps of the method comprising:
providing a printed circuit board having a plurality of LED lights, each of the plurality of LED lights having an adjacent printed circuit board pad;
applying solder directly onto the printed circuit board pads;
providing a positive electrode wire;
providing a negative electrode wire;
attaching an electrically conductive metal piece to the terminus of the positive electrode wire;
attaching an electrically conductive metal piece to the terminus of the negative electrode wire;
placing the conductive metal piece of the positive electrode wire on the solder of one of the printed circuit board pads;
heating the conductive metal piece of the positive electrode wire;
allowing the solder on said one of said printed circuit board pads to melt;
allowing the solder on said one of said printed circuit board pads to cool, thereby fusing the metal piece of the positive electrode wire to said one of the printed circuit board pads to form a soldered fixed connection between the metal piece and the printed circuit board pad, and hence the printed circuit board;
placing the conductive metal piece of the negative electrode wire on the solder of a second printed circuit board pad;
heating the conductive metal piece of the negative electrode wire;
allowing the solder on said second printed circuit board pad to melt; and
allowing the solder on said second circuit board pad to cool, thereby fusing the metal piece of the negative electrode wire to said printed circuit board pad to form a fixed soldered connection between the metal piece and the printed circuit board pad and hence the printed circuit board.

2. A method for soldering electrical connections to printed circuit boards as in claim 1 comprising the further step of heating the metal pieces at temperatures and for durations of time which prevent overheating of and damage to the printed circuit board.
